SEQUENCE LISTING (2 sequences)

SEQ ID NO: 1 - DNA, 60 bp, Artificial Sequence
  Synthetic
agcatcagactacatcatacatcagactactacagcatcaatacagcagcatcagacata

SEQ ID NO: 2 - DNA, 60 bp, Artificial Sequence
  Synthetic
nnnnnnnnnnnnnnnnatacatcagactactacagcatcaatacnnnnnnnnnnnnnnnn

(19) United States
(12) Patent Application Publication
(10) Pub. No.: US 2014/0229495 A1
(43) Pub. Date: Aug. 14, 2014

(54) METHOD FOR PROCESSING GENOMIC DATA

(71) Applicants: Vishnu Vardhan Makkapati, Ongole (IN); Nevenka Dimitrova, Pelham Manor, NY (US); Randeep Singh, Bangalore (IN); Sunil Kumar, Bangalore (IN)

(72) Inventors: Vishnu Vardhan Makkapati, Ongole (IN); Nevenka Dimitrova, Pelham Manor, NY (US); Randeep Singh, Bangalore (IN); Sunil Kumar, Bangalore (IN)

(73) Assignee: KONINKLIJKE PHILIPS N.V., Eindhoven (NL)

(21) Appl. No.: 13/979,908

(22) PCT Filed: Jan. 19, 2012
(86) PCT No.: PCT/IB2012/050255

§ 371 Date: Jul. 16, 2013

Related U.S. Application Data
(60) Provisional application No. 61/434,017, filed on Jan. 19, 2011.

(51) Int. Cl. G06F 19/18

(52) U.S. Cl. CPC G06F 19/18
USPC 707/756

(57) ABSTRACT

The present invention relates to a method for processing a subject's genomic data comprising (a) obtaining a subject's genomic sequence; (b) reducing the complexity and/or amount of the genomic sequence information; and (c) storing the genomic sequence information of step (b) in a rapidly retrievable form. The present invention further relates to a method wherein the step of reducing the complexity and/or amount of the genomic sequence information is carried out by cropping said genomic sequence information except for signature data pertaining to a disease or disorder, or by aligning a subject's genomic sequence with a reference sequence comprising signature data pertaining to a disease or disorder. Furthermore, the invention relates to a method wherein the use of a subject's functional genetic information, in particular gene expression data is included, as well as to a method, wherein the information is encoded in matrices and decoded and represented based on Markov chain processes. The obtained information can also be used for diagnosing, detecting, monitoring or prognosticating a disease and/or for the preparation of a subject's molecular history. In addition, a corresponding clinical decision support and storage system, preferably in the form of an electronic picture/data archiving and communication system, is provided.

### FIELD OF THE INVENTION

The present invention relates to a method for processing a subject's genomic data comprising (a) obtaining a subject's genomic sequence; (b) reducing the complexity and/or amount of the genomic sequence information; and (c) storing the genomic sequence information of step (b) in a rapidly retrievable form. The present invention further relates to a method wherein the step of reducing the complexity and/or amount of the genomic sequence information is carried out by cropping said genomic sequence information except for signature data pertaining to a disease or disorder, or by aligning a subject's genomic sequence with a reference sequence comprising signature data pertaining to a disease or disorder. Furthermore, the invention relates to a method wherein the use of a subject's functional genetic information, in particular gene expression data, is included, as well as to a method, wherein the information is encoded in matrices and decoded and represented based on Markov chain processes. The obtained information can also be used for diagnosing, detecting, monitoring or prognosticating a disease and/or for the preparation of a subject's molecular history. In addition, a corresponding clinical decision support and storage system, preferably in the form of an electronic picture/data archiving and communication system, is provided.

### BACKGROUND OF THE INVENTION

With the introduction of new or next generation sequencing techniques the costs for obtaining sequence information and the time needed for the provision of this information have been dramatically reduced and will be further decreased in the future. Thus, whole genome sequencing is becoming a cost effective alternative to existing biochemical and genetic tests and assays. Moreover, a patient's whole genome sequence can be used for the analysis of not only one disorder, but for the assessment of an entire group of disease genotypes and additionally allows conclusions of treatment prospects due to a simultaneous elucidation of all possible secondary markers. However, genomic sequence data is extremely voluminous requiring significant amounts of storage capacity, as well as high-end computational devices for its analysis. Schuster et al., 2010, Nature 463(18), 943-947 and Fujimoto et al, 2010, Nature Genetics, 42, 931-936 provide, for example, information on complete genomes of hunter-gatherer people from Africa and a Japanese individual, respectively. Theses analyses provide a plethora of new information on the presence of single nucleotide variations, population differences between human populations, as well as allelic frequencies. The encountered genomic differences and similarities may be of fundamental importance for basic research in the genomic field. However, they are of only minor interest to the professional, who is concerned with a specific clinical question and would like to have focused information with regard to identified symptoms or suspected diseases. In this context, most of the genomic sequence data obtained during whole genome sequencing runs will rather hamper than improve the professional's diagnostic possibilities.

There is, thus, a need for a method allowing a time and resource preserving handling of a patient's genomic data.

### SUMMARY OF THE INVENTION

The present invention addresses this need and provides means and methods, which allow the reduction of complexity and/or amount of a subject's genomic sequence and its storage in a rapidly retrievable form.

The above objective is in particular accomplished by a method for processing a subject's genomic data comprising the steps of:

(a) obtaining a subject's genomic sequence;

(b) reducing the complexity and/or amount of the genomic sequence information; and

(c) storing the genomic sequence information of step (b) in a rapidly retrievable form.

This method provides the advantage that genomic information becomes easily and in a focused and processed manner accessible to the professional or physician, i.e. the genomic information is manageable and limited to the necessary facts, thus allowing a time and resource preserving handling of extremely high volumes of raw sequence data. Its storing in a rapidly retrievable form furthermore allows for an expeditious, immediate and locally unrestrained and independent usage, e.g. in problematic clinical environments, in mobile hospitals, or at the patients' bedside etc.

In a preferred embodiment of the present invention, the genomic sequence is obtained from a subject's sample.

In a further preferred embodiment the sample to be analyzed is a mixture of tissues, organs, cells. The sample may also, or alternatively, comprise fragments of tissues, organs or cells. In a further embodiment, the sample may be a tissue or organ specific sample. Particularly preferred are tissue biopsy samples from vaginal tissue, tongue, pancreas, liver, spleen, ovary, muscle, joint tissue, neural tissue, gastrointestinal tissue, tumor tissue, body fluids, blood, serum, saliva, or urine.

In a further, particularly preferred embodiment of the present invention the step of obtaining a subject's genomic sequence may be repeated, e.g. after a certain time period.

In a further preferred embodiment of the present invention the repetition of obtaining a subject's genomic sequence may lead to data increments or variations wherein the incremental data in comparison to the previously obtained genomic sequence information is stored, preferably in a rapidly retrievable form.

In a further, particularly preferred embodiment of the present invention the step of reducing the complexity and/or amount of the genomic sequence information may be carried out by cropping said genomic sequence information. Such a cropping or reducing step is preferably carried out on all parts of the genomic sequence except for signature data pertaining to a disease or disorder.

In yet another, particularly preferred embodiment of the present invention the step of reducing the complexity and/or amount of the genomic sequence information may be carried out by aligning a subject's genomic sequence with a reference sequence comprising signature data pertaining to a disease or disorder (disease reference sequence).

In another preferred embodiment of the present invention said signature data is at least one variation specific to a disease or disorder selected from the group comprising missense mutation, nonsense mutation, single nucleotide polymorphism (SNP), copy number variation (CNV), splicing variation, variation of a regulatory sequence, small deletion, small insertion, small indel, gross deletion, gross insertion, complex genetic rearrangement, inter chromosomal rearrangement, intra chromosomal rearrangement, loss of heterozygosity, insertion of repeats and deletion of repeats.

In yet another preferred embodiment of the present invention the method for processing a subject's genomic data additionally comprises the steps of (d) obtaining the subject's functional genetic information, (e) reducing the complexity and/or amount of this information, and (f) storing the functional genetic information in a rapidly retrievable form.

In another particularly preferred embodiment of the present invention said functional genetic information comprises (i) information on gene expression, preferably information on the presence of one or more RNA species, of one or more protein species, of the subject's transcriptome or a portion thereof, of the subject's proteome or a portion thereof, or of a mixture thereof; and/or (ii) methylation sequencing information, preferably methylation sequencing information for each individual nucleotide (C or A); and/or (iii) information on histone marks which are indicative of active genes and/or silenced genes, preferably of H3K4 methylation and/or H3K27 methylation.

In another preferred embodiment the step of reducing the complexity and/or amount of the information may be carried out by cropping said functional genetic information. Such a cropping or reducing step is preferably carried out on all portions of the functional genetic information except for signature data pertaining to a disease or disorder (disease reference sequence).

In a further preferred embodiment of the present invention, the changes in genomic information and/or functional genetic information are encoded in matrices. In yet another preferred embodiment, genomic information and/or functional genetic information pertaining to the status of a gene, genomic region, regulatory region, promoter, exon, or pathway, preferably in the context of a disease or disorder, is decoded and represented based on Markov chain processes. In a particularly preferred embodiment said representation is a visual representation.

In another aspect, the present invention relates to the use of the genomic sequence information for the preparation of a subject's molecular history. In a preferred embodiment of the present invention genomic sequence information in combination with functional genetic information as obtained and/or stored according to methods as defined herein above may be used for the preparation of a subject's molecular history.

In a particularly preferred embodiment said molecular history is generated by capturing functional aspects of the complete genome, of the regulome, or of the regulatory state of the genome, genomic regions, genes, promoters, introns, exons, pathways, pathway members or methylation states over a defined period of time.

In another aspect the present invention relates to the use of genomic sequence information as obtained and/or stored according to methods as defined herein above, for diagnosing, detecting, monitoring or prognosticating a disease. In a preferred embodiment of the present invention genomic sequence information in combination with functional genetic information as obtained and/or stored according to methods as defined herein above may be used for diagnosing, detecting, monitoring or prognosticating a disease.

In a particularly preferred embodiment of the present invention said disease or disorder as mentioned in the context of the methods or uses as described herein above may be a cancerous disease, tumor disease or neoplasm. In a further particularly preferred embodiment of the present invention said cancerous disease may be a breast cancer, an ovarian cancer or a prostate cancer.

In another aspect the present invention relates to a clinical decision support and storage system comprising an input for providing a subject's genomic sequence information; a computer program product for enabling a processor to carry out the step of reducing the complexity and/or amount of the genomic sequence information as defined herein above, an output for outputting a subject's genomic variation, incremental genomic change or gene expression variation pattern, and a medium for storing the outputted information. In a specific embodiment the clinical decision support and storage system may comprise an input for providing a subject's genomic sequence information in combination with a subject's functional genetic information, preferably gene expression information; a computer program product for enabling a processor to carry out the step of reducing the complexity and/or amount of the genomic sequence information and the step of reducing the complexity and/or amount of the functional genetic information, preferably gene expression information as defined herein above, an output for outputting a subject's genomic variation, incremental genomic change or functional genetic variation pattern, preferably gene expression variation pattern, and a medium for storing the outputted information.

In preferred embodiment of the present invention said system may be an electronic picture/data archiving and communication system.

### BRIEF DESCRIPTION OF THE DRAWINGS

FIG. 1 provides a complete pipeline of a traditional whole genome sequencing (WGS) pipeline.

FIG. 2 provides an overview of comparison and alignment steps to be taken in order to reduce the complexity and amount of a subject's genomic sequence.

FIG. 3 shows a comparison between a reference sequence and a disease reference sequence according to the present invention, with relevant nucleotides of the disease reference sequence highlighted in chromosome 1.

FIG. 4 shows a situation in which mutations are close together. In such a situation longer sequence stretches covering all mutations are prepared.

FIG. 5 depicts typical steps of a monitoring approach for a subject's progress over time.

FIG. 6 shows the variation in Gene Copy Number (GCN) polymorphisms after the onset of disease and after treatment. The status of certain genes (being up-regulated or down-regulated) is represented in a graphical model based on finite Markov chain processes. Since a Markov chain is a process that moves through a set of states in successive manner, moving from state A to a state B will occur with a certain probability. These probabilities are represented in the form of a transition matrix. Within this transition matrix, the values in italics represent the states that have changed during the progression of disease and the values in block letters represent the states that have not been restored completely.

FIG. 7 shows the variation in Gene Copy Number (GCN) polymorphisms during the progression of a disease. This figure shows sample intermediate data obtained using sequencing where in the original Gene Copy Number of FIG. 6 has been modified during the progression of the disease (i.e., matrix 1 to matrix 2 of FIG. 6). These incremental changes become keys to study progression of the disease and determine disease progression patterns across a given genetic population. Each matrix thus represents a different state of the disease.

### DETAILED DESCRIPTION OF EMBODIMENTS

The inventors have developed means and methods, which allow the reduction of complexity and/or amount of a subject's genomic sequence and its storage in a rapidly retrievable form.

Although the present invention will be described with respect to particular embodiments, this description is not to be construed in a limiting sense.

Before describing in detail exemplary embodiments of the present invention, definitions important for understanding the present invention are given.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(a)”, “(b)”, “(c)”, “(d)” etc. relate to steps of a method or use there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As has been set out above, the present invention concerns in one aspect a method for processing a subject's genomic sequence comprising

(a) obtaining a subject's genomic sequence;

(b) reducing the complexity and/or amount of the genomic sequence information; and

(c) storing the genomic sequence information of step (b) in a rapidly retrievable form.

In a first step of the method a subject's genomic sequence may be obtained. A “subject” as used herein may be any organism comprising a genome. Preferably, the subject is a human being. Alternatively, the genomic sequence of an animal, e.g. a companion animal such as a dog, a cat, a cow, a horse, a pig etc., or the genomic sequence of a plant may be obtained. The methods of the present invention are, however, not limited to these groups of organisms, but can generally be used with any subject or organism comprising genetic, in particular genomic information.

The term “obtaining a subject's genomic sequence” as used herein refers to the determination of the genomic sequence of a subject. Methods for sequence determination are known to the person skilled in the art. Preferred are next generation sequencing methods or high throughput sequencing methods. For example, a subject's genomic sequence may be obtained by using Massively Parallel Signature Sequencing (MPSS). An example of an envisaged sequence method is pyrosequencing, in particular 454 pyrosequencing, e.g. based on the Roche 454 Genome Sequencer. This method amplifies DNA inside water droplets in an oil solution with each droplet containing a single DNA template attached to a single primer-coated bead that then forms a clonal colony. Pyrosequencing uses luciferase to generate light for detection of the individual nucleotides added to the nascent DNA, and the combined data are used to generate sequence read-outs. Yet another envisaged example is Illumina or Solexa sequencing, e.g. by using the Illumina Genome Analyzer technology, which is based on reversible dye-terminators. DNA molecules are typically attached to primers on a slide and amplified so that local clonal colonies are formed. Subsequently one type of nucleotide at a time may be added, and non-incorporated nucleotides are washed away. Subsequently, images of the fluorescently labeled nucleotides may be taken and the dye is chemically removed from the DNA, allowing a next cycle. Yet another possible and envisaged method of obtaining a subject's genomic sequence is the use of Applied Biosystems' SOLiD technology, which employs sequencing by ligation. This method is based on the use of a pool of all possible oligonucleotides of a fixed length, which are labeled according to the sequenced position. Such oligonucleotides are annealed and ligated. Subsequently, the preferential ligation by DNA ligase for matching sequences typically results in a signal informative of the nucleotide at that position. Since the DNA is typically amplified by emulsion PCR, the resulting bead, each containing only copies of the same DNA molecule, can be deposited on a glass slide resulting in sequences of quantities and lengths comparable to Illumina sequencing. A further envisaged method is based on Helicos' Heliscope technology, wherein fragments are captured by polyT oligomers tethered to an array. At each sequencing cycle, polymerase and single fluorescently labeled nucleotides are added and the array is imaged. The fluorescent tag is subsequently removed and the cycle is repeated. Further examples of sequencing techniques encompassed within the methods of the present invention are sequencing by hybridization, sequencing by use of nanopores, microscopy-based sequencing techniques, microfluidic Sanger sequencing, or microchip-based sequencing methods. The present invention also envisages further developments of these techniques, e.g. further improvements of the accuracy of the sequence determination, or the time needed for the determination of the genomic sequence of an organism etc.

The genomic sequence may be obtained in any suitable quality, accuracy and/or coverage. The acquisition of the genomic sequence also includes the employment of previously or independently obtained sequence information, e.g. from databases, data repositories, sequencing projects etc.

Preferably, a genomic sequence obtained may have no more than one error in every 10,000 bases, in every 50,000 bases, in every 75,000 based, in every 100,000 bases. More preferably, a genomic sequence obtained may have no more than one error in every 150,000 bases, 200,000 bases or 250.000 bases.

In a further, specific embodiment, the genomic sequence obtained may have a coverage of at least 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.99%, 99.999% or 100%. In a further specific embodiment the genomic sequence obtained may have an average read depth per haploid genome of at least about 15×, 20×, 25×, 30×, 35×, 40× or more, or any other average depth between 15× and 50×, or more. The present invention also envisages the preparation or use of sequences having a higher coverage due to improvements in the sequencing technology. The present invention is accordingly not bound by any error margins or coverage limits, and instead focuses on the implementation of the sequence information available, prepared and obtained according to suitable contemporary sequencing techniques.

In a preferred embodiment of the present invention, an average read depth of the obtained genomic sequence of at least about 15×, 20×, 25×, 30×, 35×, 40× or more per haploid genome, or any other average depth between 15× and 50× may be confined to one or more sub-portions of the genome, e.g. to one or more or all regulatory regions, to an open reading frame, to open reading frames of pathway members, to all open reading frames, to one or more promoter regions, to one or more enhancer elements, to regulatory network members or any other suitable subset of genomic regions, e.g. defined by signature data pertaining to a disease or disorder. In a particularly preferred embodiment of the present invention in a regulatory region, or in a region defined by signature data pertaining to a disease or disorder, each base may be covered by at least about 15, 20, 25, 30, 35, 40 or more sequencing reads, or by any other number of reads between 15 and 50. The present invention also envisages the preparation or use of sequences having a higher read depth due to improvements in the sequencing technology. The present invention is accordingly not bound by any error margins or read depth limits, and instead focuses on the implementation of the sequence information available, prepared and obtained according to suitable contemporary sequencing techniques.

A subject's genomic sequence may be obtained by any suitable in vitro and/or in vivo methodology. Particularly preferred is obtaining the genomic sequence from a sample obtained from the subject, e.g. a sample as defined herein below. In specific embodiments of the present invention the method for processing a subject's genomic data also includes a step of obtaining a sample or of carrying out a biopsy.

In further embodiments, the subject's genomic sequence may also be obtained from data repositories, e.g. from one ore more databases containing a subject's genomic sequence, or from one or more database entries by reconstructing a subject's genomic sequence.

The obtained genomic sequence may be present in any suitable format known to the person skilled in the art. For example, the sequence may be present as raw data, in the FASTA format, in plain text format, as unicode text, in xml format, in html format. Preferably, the obtained genomic sequence may be present in the Variant Call Format (VCF), the General Feature Format (GFF), the BED format, the AVLIST or the Annovar format.

In a second step of the method the complexity and/or amount of the genomic sequence information is reduced. The term “complexity” as used herein refers to the amount of variability of information present in the genomic sequence, the redundancy of sequence information present in the genomic sequence, the coverage of known chromosomal regions, genes, or spots of increased likelihood of mutation, as well as further parameters of genetic variability known to the person skilled in the art. The “amount of genomic sequence” as used herein refers to the coverage of the sequence information, e.g. the coverage of chromosomes, of chromosomal regions, genes, genetic elements, introns, exons, disease-associated regions or genes etc. By reducing the complexity and/or amount of the genomic sequence thus the overall sequence data obtained in the first step is preferably filtered according to different suitable parameters, such as the presence of intergenic regions, the presence of introns or exons, the presence of transposable elements, the presence of repetitive elements, the presence of spots or regions of known mutations. For example, only the sequence of exons (exome), may be obtained, or of a certain sub-group of the exons. Likewise, only the sequence of introns may be obtained, or of a certain sub-group of the introns, or of intron-exon borders etc. Further filter parameter may be the localization on chromosomes. For example, the data may be reduced to one, two, three etc. chromosomes, or the chromosomal arms or chromosomal regions according to dying schemes or expression pattern etc. Further envisaged filter parameter may be known expression pattern, e.g. derived from biochemical pathways, transcription factor pathways, expression pattern due to growth factor or ligand activity, expression pattern due to certain nutritional situations etc. Yet another set of filter parameters may be known polymorphisms throughout the genome, known polymorphisms on a specific chromosome, known polymorphisms in a gene, known polymorphisms in an intergenic region, known polymorphisms in a promoter region etc. Further filter parameters may be linked with known data on a disease, a group of diseases, a predisposition for a disease, e.g. a filter parameter may comprise all information on genomic modifications associated with a specific disease, group of diseases or predisposition for the disease.

In a specific embodiment of the present invention the genomic sequence information may be reduced to genomic regions, whole genes, exons (the exome sequence), transcription factor binding sites, DNA methylation-binding-protein binding sites, intergenic regions which may include short or long non-coding RNAs, etc. which are known or suspected to be clinically relevant or important and might be variable or highly variable between human beings, between different human races, or populations, between the human or animal sexes, between age groups of human beings, e.g. between newborn babies and adults, between human beings and other organisms etc., between animals of the same race, between animals of different races, species, genera or classes, between plant varieties, plant species etc., or which are known or suspected to be variable or highly variable in diseases or disorders. Such genomic regions, genes, exons, binding sites etc. would be known to the person skilled in the art or could be derived from suitable textbooks or information repositories, e.g. from the UCSC genome browser or from NCBI.

A reduction of the complexity and/or amount of the genomic sequence may be carried out in one or more steps, e.g. based on comparison methods or algorithms, motif finding methods or algorithms, iterative processes etc. as would be known to the person skilled in the art. For example, the reduction may be carried out based on methods described in suitable textbooks or scientific documents such as S. Kurtz, A. Phillippy, A. L. Delcher, M. Smoot, M. Shumway, C. Antonescu, and S. L. Salzberg, 2004, “Versatile and open software for comparing large genomes”, Genome Biology, 5:R12, Schuster et al., 2010, Nature 463(18), 943-947 or Fujimoto et al, 2010, Nature Genetics, 42, 931-936, which are all incorporated herein by reference in their entirety.

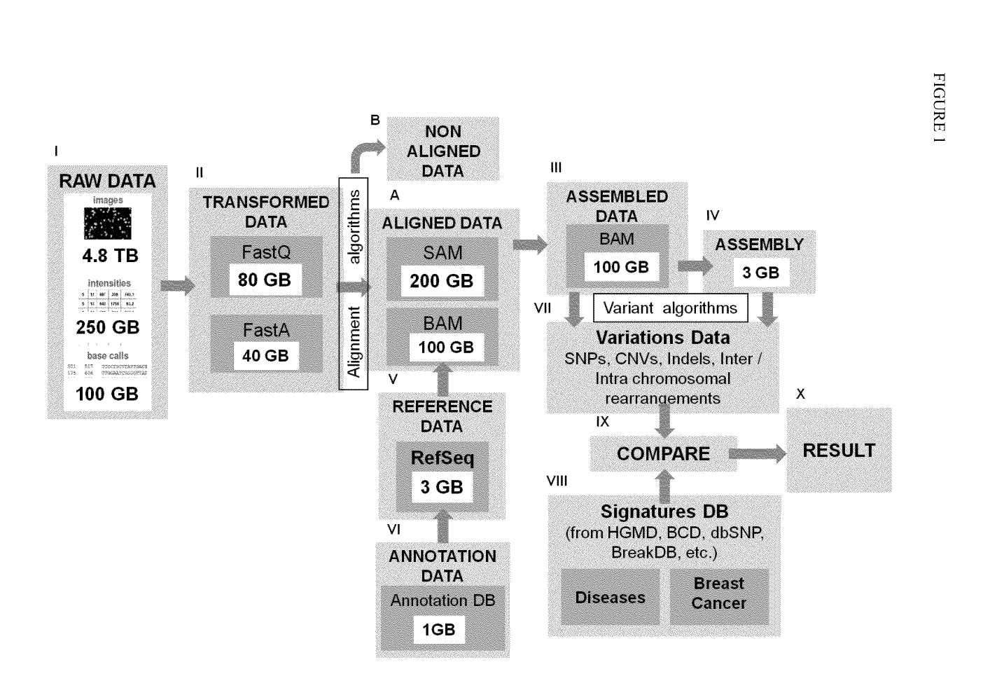

Further envisaged methods for the reduction of the complexity and/or amount of the genomic sequence may be derived from Ashley et al., 2010, The Lancet, 375, 1525-1535, which is also incorporated herein by reference in its entirety. In particular, a reduction of the complexity based on molecular information regarding genomic variants as provided in FIG. 1 of said publication is envisaged by the present invention.

In a further specific embodiment, a reduction of the complexity and/or amount of the genomic sequence based on the information provided by the Pharmacogenomic Knowledge Base (PharmGKB) with respect regard to drug-response phenotypes, the locus-specific mutation database (LSMD) or the human mitochondrial genome polymorphism database (mtSNP) is envisaged.

Particularly preferred is the employment of population-based filters for the obtained genomic information. For example, genomic sequence variations, in particular SNPs, detected by comparison methods as defined herein above, may be further compared with or analysed within the context of the patient's population, race, or ancestry. Thus, if for instance there is a variant SNP known for a specific population, race, age group etc., this variant may not be reported or identified as relevant or filtered out for the purpose of the present invention. In specific embodiments, such variants may—although being specific or typical for a population, race, age group etc—be considered and identified as relevant for the purpose of the present invention, if the variant shows an important/clinical functional implication. An example of a functionally important class of SNPs, which may appear in a whole population is in the CYP related genes which help to metabolize and excrete the drugs. Since certain drugs are known to be tolerated at a different, e.g. lower dosages in different populations, e.g. in non-Caucasian), variants in CYP-related genes may be filtered, sorted, classified and/or assessed in accordance with the patient's population affiliation, or the patient's race. Such a filtering may, for example, be carried out on the basis of information provided in the PharmGKB database.

The filtered or reduced genomic sequence may be present in any suitable format or form. Preferably, the sequence may be present in the FASTA format, in plain text format, as unicode text, in xml format, in html format, in Variant Call Format (VCF), in General Feature Format (GFF), in BED format, in AVLIST format or in Annovar format. Furthermore, the genomic sequence may be present in a derivative format, e.g. as database entry, annotated database entry, list of points of genomic/genetic modifications, preferably sorted by relevance or number of occurrence, e.g. occurrence in the population etc.

In a third step of the method the genomic sequence information as obtained in the second step is stored in a rapidly retrievable form. The information to be stored may have any suitable form or format, e.g. a form or format as mentioned herein above. The storage of the genomic information should preferably be limited to the available space on a suitable storage medium, e.g. a computer hard drive, a mobile storage device or the like. Particularly preferred is a storage structure which is 1) hierarchical, and/or 2) encodes time information and/or additionally 3) contains links to patient data, images, reports etc. Even more preferred is a storage structure such as Differential DNA Storage Structure (DDSS).

The term “rapidly retrievable” as used herein means that the genomic information is provided in a form, which allows an easy access to the information and/or allows an uncomplicated extraction of the stored information. Storage forms envisaged by the present invention are a suitable database storage, a storage in lists, numbered documents and/or in graphical form, e.g. as pictograms, graphical alignments, comparison schemes etc. In a specific embodiment of the present invention, the information may be retrieved from a storage medium and subsequently be displayed, e.g. on any suitable monitor, handheld device, computer device or the like.

In a specific embodiment of the present invention the method for processing a subject's genomic sequence comprises the steps of (a) reducing the complexity and/or amount of the genomic sequence information as defined herein above; and of (b) storing the genomic sequence information of step (a) in a rapidly retrievable form as defined herein above.

In a preferred embodiment of the present invention the sample to be analyzed for obtaining a subject's genomic sequence may be derived from any suitable part or portion of a subject's body or organism. The sample may, in one embodiment, be derived from pure tissues or organs or cell types, or derived from very specific locations, e.g. comprising only one type of tissue, cell, or organ. In further embodiments, the sample may be derived from mixtures of tissues, organs, cells, or from fragments thereof. Samples may preferably be obtained from organs or tissues such as the gastrointestinal tract, the vagina, the stomach, the heart, the tongue, the pancreas, the liver, the lungs, the kidneys, the skin, the spleen, the ovary, a muscle, a joint, the brain, the prostate, the lymphatic system or organ or tissue known to the person skilled in the art. In further embodiments of the invention the sample may be derived from body fluids, e.g. from blood, serum, saliva, urine, stool, ejaculate, lymphatic fluid etc.

Particularly preferred is the employment of tumor tissue or the use of a sample derived from an organ known to be cancerous. Also envisaged is the use of samples derived from any other organ or tissue or cell or cell type associated with or diagnosed to be affected by a disease, infection, disorder etc. In a specific embodiment of the present invention the sample may contain cells obtained from a solid tumor, from a tissue resection suspected to be tumorous or cancerous, from a biopsy of a diseased organ or tissue, e.g. an infected or cancerous organ or tissue, etc. The infection may, for example, be a bacterial or viral infection.

The sample may contain one or more than one cell, e.g. a group of histologically or morphologically identical cells, or a mixture of histologically or morphologically different cells. Preferred is the use of histologically identical or similar cells, e.g. stemming from one confined region of the body.

Further envisaged is the use of samples obtained from the same subject at different points in time, obtained from different organs or tissues of the same subject, or form different organs or tissues of the same subject at different points in time. For example, a sample of a tumor tissue and of one or more samples of a neighbouring, non-cancerous region of the same tissue or organ may be taken and used for obtaining a subject's genomic sequence.

In case of non-human or non-animal subjects samples may be derived from other tissue types, e.g. specific plant tissues to be used may include for instance leafs, root tissue, meristematic tissue, fluorescence tissue, tissue derived from plant seeds etc.

A subject's genomic sequence may thus, depending on the sample taken, comprise a mixture of genomic sequence information, e.g. derived from different tissues, organs, and/or cells of the subject; or it may comprise genomic information derived from a specific, singular source of the subject, e.g. one organ or organ type, one tissue or tissue type, one cell or cell type and accordingly represent the corresponding organ's, tissue's or cell's genomic situation. In case of cancerous organs or tissues, the employment of specifically selected samples as well as the support of the biopsy by histological methods and approaches is also envisaged by the present invention.

In a further embodiment of the present invention a subject's genomic sequence may be obtained initially, followed by a subsequent repetition of the obtaining step. Preferably, the acquisition of a subject's genomic sequence may be repeated one time, two times, 3 times, 4 times, 5 times, 6 times or more often. The second or further acquisition may be carried out after a certain period of time, e.g. after 1 week, 2 weeks, 3 weeks, 4 weeks, 2, 3, 4, 5, 6, 7, 8, 9, 10, 11, 12 months, 1.5 years, 2 years, 3 years, 4 years, 5 years, 6 years etc. or after a longer period of time or at any suitable point in time in between these time points. The time periods between 1^{st} and a 2^{nd} and a 2^{nd} a subsequent acquisition of a subject's genomic sequence may be identical, essentially identical or may differ, e.g. increase or decrease. For instance, during a treatment monitoring, a subject's genomic sequence may be obtained in equal or increasing or decreasing intervals.

Typically, when a subject's genomic sequence is obtained at a further instance after the initial acquisition, the same organ, tissue, cell, organ type, tissue type, cell type, or the same sample type, e.g. urine, blood, serum, saliva sample etc. as in the initial acquisition may be used. Alternatively, non-identical organs, tissues, cells, organ types, tissue types, cell types or sample types etc. may be targeted for a subsequent acquisition of a subject's genomic sequence. Further envisaged is an initial acquisition of a subject's genomic sequence from a mixture of tissues, organs, cells etc, followed by the acquisition of a subject's genomic sequence from a defined, specific source, e.g. a specific organ, tissue, cell, organ type, tissue type or cell type as defined herein above. Alternatively, an initial acquisition of a subject's genomic sequence from a defined, specific source, e.g. a specific organ, tissue, cell, organ type, tissue type or cell type may be followed by the acquisition of a subject's genomic mixture of tissues, organs, cells etc. For example, during the treatment of a disease, e.g. cancer, the latter approach may be taken in order to cover a residual presence of modified or abnormal cells, cell types or tissue portions.

In further embodiment of the present invention a subject's genomic sequence may be obtained simultaneously or in parallel from two or more different locations, organs, tissues, cells, tissue types, cell types etc. correspondingly obtained genomic sequence information can also be processed as described herein above or below.

The methods for obtaining a subject's genomic sequence initially and subsequently, or when performing parallel sequence acquisition may be the same or may differ. It is preferred that the sequencing techniques and/or the resulting data format etc. be essentially identical.

After a subject's genomic sequence is obtained for a second or further time after the initial acquisition, or if more than one genomic sequence is obtained at a time, a comparison between the genomic sequence information obtained, e.g. in the initial acquisition and the genomic sequence information obtained in the second or further acquisition is performed. Preferably, such a comparison is carried out to reveal changes, modifications or differences between the initially obtained genomic sequence and the subsequently obtained genomic sequence, or between the genomic sequences obtained in different locations, organs, tissues, cells etc. The term “comparison” as used herein relates to any suitable method or technique of matching two genomic sequences. Typically, alignment algorithms as known to the person skilled in the art may be employed in order detect differences between the two genomic sequences. Examples of such algorithms include methods as derivable from S. Kurtz, A. Phillippy, A. L. Delcher, M. Smoot, M. Shumway, C. Antonescu, and S. L. Salzberg, 2004, “Versatile and open software for comparing large genomes.”, Genome Biology, 5:R12. Further examples of suitable and envisaged algorithms include the UMKA algorithm for base calling (Pushkarev et al., Nat Biotechnology, 2009, 27: 847-52, which is incorporated herein by reference in its entirety) and algorithms provided by Ashley et al., 2010, The Lancet, 375, 1525-1535.

In one embodiment of the present invention a comparison is carried out between the entire genomic sequences obtained in the initial acquisition and second or subsequent acquisition process, or between the simultaneously obtained genomic sequences. This provides a complete overview over all modifications, changes and differences throughout the entire genomic sequence.

In another embodiment of the present invention a comparison is carried out between a filtered or reduced genomic sequence or genomic sequence information as described herein above. Preferably, the initially obtained genomic sequence or the simultaneously obtained genomic sequences which are reduced to genomic regions, whole genes, exons (the exome sequence), transcription factor binding sites, DNA methylation-binding-protein binding sites, intergenic regions which may include short or long non-coding RNAs, etc. which are known or suspected to be clinically relevant or important and might be variable or highly variable between human beings, between different human races, or populations, between the human or animal sexes, between age groups of human beings, e.g. between newborn babies and adults, between human beings and other organisms etc., between animals of the same race, between animals of different races, species, genera or classes, between plant varieties, plant species etc., or which are known or suspected to be variable or highly variable in diseases or disorders, may be used for a comparison with a second or subsequently obtained genomic sequence.

In yet another embodiment a comparison may include further tests, e.g. tests based on methods for genetic data interpretation, data normalization, data clustering, k-means clustering, hierarchical clustering, principle component analysis, supervised methods, etc. Such additional tests would be known to the person skilled in the art or can be derived from suitable sources, e.g. from Tjaden et al, 2006, Applied Mycology and Biotechnology: Bioinformatics, 6, which is incorporated herein by reference in its entirety.

In a further embodiment, if a subject's genomic sequence obtained a third, fourth, fifth or subsequent time after the initial acquisition is compared, this comparison may be carried out with the initially obtained genomic sequence and/or with the genomic sequence obtained subsequently. Such a comparison may be carried out between the entire genomic sequence, or between a reduced or filtered subset thereof as described herein above.

In a preferred embodiment, a comparison is carried out between consecutive sets of genomic sequence information, e.g. between the genomic sequence information obtained initially and the genomic sequence information obtained in the 1^{st} repetition of genomic sequence acquisition; between the genomic sequence information obtained in the 1st repetition of genomic sequence acquisition and the genomic sequence information obtained in the 2^{nd} repetition of genomic sequence acquisition; between the genomic sequence information obtained in the 2^{nd} repetition of genomic sequence acquisition and the genomic sequence information obtained in the 3^{rd} repetition of genomic sequence acquisition, and so forth.

Alternatively, a comparison may be carried out as follows: for example between the genomic sequence information obtained initially and the genomic sequence information obtained in the 2^{nd} repetition of genomic sequence acquisition; between the genomic sequence information obtained initially and the genomic sequence information obtained in the 3^{rd} repetition of genomic sequence acquisition etc. In further embodiments, e.g. in case the genomic sequence informed has been obtained more often, all types of comparisons between each set of genomic sequence information may be carried out.

In a particularly preferred embodiment, when a subject's genomic sequence is obtained for a 2^{nd} or subsequent time, the incremental data in comparison to the genomic sequence information of the previously stored genomic sequence information is stored. The term “incremental data” as used herein refers to information which has changed or which differs between two sets of genomic sequence information given.

For example, data to be stored may comprise the location and the nature of a change. Additionally, further parameters may be stored, e.g. sequence stretches, acquisition time, the interval between the acquisition etc. Such storage may be carried out in any suitable format or form, e.g. in the form of a database entry, as graphical information, in the form of a text or portable document, or may be saved in audio or speech formats to be retrievable as audio entity for a professional. Particularly preferred is a storage structure which is 1) hierarchical, and/or 2) encodes time information and/or 3) contains links to patient data, images, reports etc. Even more preferred is a storage structure such as Differential DNA Storage Structure (DDSS).

In a specific embodiment, e.g. when a subject's genomic sequence is obtained more than two times, when the data is presented for the second time, the changes in the genetic data may be identified (i.e., the difference between G² and G¹) and only the changed segments will be stored (δG²). When the genetic data is presented for the n^{th} time (Gⁿ), the previous genetic data (Gⁿ⁻¹) may be reconstructed as

$${G}^{n - 1} = {G}^{`} + {\sum }_{i = 2}^{n - 1} δ {G}^{i}$$

The changes if any between Gⁿ and Gⁿ⁻¹ may be detected and stored as δGⁿ. The advantage of such a process is that memory and storage space required for storing the genetic information can be reduced drastically.

In a preferred embodiment of the present invention the changes, if any, between Gⁿ and Gⁿ⁻¹ may correspond to the disease states, which are preferably encoded or described in matrices (as, for example, depicted in FIG. 6). The status of certain genes (e.g. being amplified or deleted which may result in genes being up-regulated or down-regulated, respectively) may, for example, be decoded

The present invention accordingly envisages a method, wherein changes in genomic and/or functional genetic information are encoded in matrices, and wherein information pertaining to the status of a gene, genomic region, regulatory region, promoter, exon or pathway, preferably in the context of a disease or disorder, is decoded and represented by suitable processes.

In preferred embodiment the status of a gene, genomic region, regulatory region, promoter, exon or pathway etc., preferably in the context of a disease or disorder, may be decoded from such a matrix or condensed representation and may be visually represented in a suitable graphical model.

Preferably, such a graphical model is based on finite Markov chain processes. Since a Markov chain is a process that moves through a set of states in successive manner, moving from state A to a state B will occur with a certain probability. These probabilities may be represented as a matrix, preferably in the form of a transition matrix. As illustrated in FIG. 7, which shows a set of states in successive manner, matching a patient's profile and making an informed decision of the patient may transition from state A to a state B with a certain probability. The advantage of such a process is that (i) memory and storage space required for storing the genetic information can be reduced drastically, and that (ii) the representation is conducive to matching with matrices that are representing states in a disease progression (or regression). In this manner, the stored representation may easily conform to a clinical decision support software that matches the transition states and may help in making diagnostic decisions.

In a specific embodiment of the present invention the reducing of the complexity and/or amount of the genomic sequence and/or of functional genetic information as mentioned above, and/or the encoding or analysis of the changes in genomic and/or functional genetic information may be carried out or be based on the use of Probabilistic Boolean Networks (PBNs). Such PBNs may be used as rule-based paradigm for modeling approaches, e.g. for modeling of regulatory networks, or for filtering or linking data or information, e.g. as mentioned herein. The present invention thus also envisages the employment of such networks as subclass of Markovian Genetic Regulatory Networks, e.g. within the context of Markov chain processes as described herein. In one embodiment the PBNs may be used to represent interactions between different genes, pathways, states of disease, disease factors, molecular disease symptoms, or any other suitable information known to the person skilled in the art. Suitable implementations and the formalisms of PBNs would be known to the skilled person, or could be derived from qualified scientific documents, e.g. from Hamid Bolouri, Computational Modelling Of Gene Regulatory Networks, 2008, Imperial College Press.

Such a representation as well as the corresponding implementation in the form of clinical decision support software is, thus, also envisaged by the present invention.

In a further embodiment of the present invention the method as defined herein above may also include a step of monitoring the changes or differences over time. Additionally or alternatively the method may include a step of predicting a trend, e.g. an improvement or aggravation trend during a treatment process, or during the course of a disease.

In yet another embodiment the method may additionally comprise the calculation of associated risk factors, e.g. based on (δGⁿ). In case, the change in genetic data (δGⁿ) does not or not directly suggest the risk that the person is susceptible to, (δGⁿ) in combination with one or more of (δG², δG³, . . . , δGⁿ⁻¹) may be used for a calculation of a risk factor. The term “risk factor” or “risk” as used herein refers to the likelihood to develop a disease and/or the likelihood that a disease deteriorates or moves on to a next stage or level or that a predisposition for a disease turns into a disease.

In a particularly preferred embodiment all possible combinations of incremental data may be analyzed to derive the risks. Accordingly, the complexity in analyzing the genetic data for risks, as it does not process the voluminous data (G¹, G², . . . , Gⁿ), may be significantly reduced. In a specific embodiment, the stored representation may be used to make disease preventive steps. In further embodiments, the stored representations may be used to carry out more frequent screenings, preferably by using imaging or other diagnostic modalities.

In a further specific embodiment, the stored genomic sequence date may be provided with an option to permit access only to the incremental data, i.e., (δG², δG³, . . . , δGⁿ) as these data would be sufficient for use by a professional. Such a possibility offers the additional advantage that the subject can keep his genetic or genomic data private without revealing it.

In a further particularly preferred embodiment of the present invention the step of reducing the complexity and/or amount of the genomic sequence information may be carried out by cropping said genomic sequence information except for signature data pertaining to a disease or disorder. The term “cropping the genomic sequence information as used herein” refers to a focusing or deleting process to be carried out on the genomic sequence sets as obtained in initial or subsequent rounds of genomic sequence acquisition. Accordingly, non-relevant and/or redundant genomic sequence information may be deleted or removed from the starting set of genomic information. Such a focusing or cropping step is typically based on signature data for genetic situations, disorders, diseases, predispositions for disorders or diseases, risk factors for the development of diseases etc.

The term “signature data” as used herein refers to information on a genetic or genomic variation. Preferably, such a signature data may be information on a genetic or genomic variation specific to a disorder, disease, predisposition for disorders or diseases, risk factors for the development of diseases etc. Alternatively, signature data may also comprise data which is not per se linked to a disease or disorder, but provide information on a subject's fitness, robustness, adaptation to specific conditions, potential of adaptability, history of modifications, or information necessary for the subject's or the subject's progeny's identification, e.g. in criminal investigations, fingerprinting approaches, paternity tests etc.

In a preferred embodiment a signature data may be or provide information on at least one variation specific to a disorder, disease, predisposition for disorders or diseases, risk factors for the development of diseases etc., selected from a missense mutation, a nonsense mutation, a single nucleotide polymorphism (SNP), a copy number variation (CNV), a splicing variation, a variation of a regulatory sequence, a small deletion, a small insertion, a small indel, a gross deletion, a gross insertion, a complex genetic rearrangement, an inter chromosomal rearrangement, an intra chromosomal rearrangement, the loss of heterozygosity, the insertion of repeats and/or the deletion of repeats and/or any combination of these signatures. Further suitable genetic variations and modifications of the genome or a subject's genetic sequence or state or signature data as known to the person skilled in the art are also encompassed within the present invention.

In further embodiments of the present invention, the signature data may be linked to specific genes or loci known to be associated with specific diseases, e.g. HER2, EFGR, KRAS, BRAF, Bcr-abl, PTEN, PI3K, BRCA1, BRCA2, GATA 4, CDKN2A, PARP, p53, etc. Such marker signatures may, of course, also be combined with additional parameters or additional genetic information, e.g. SNPs, copy number variations etc.

In a particularly preferred embodiment a signature data may be or provide on information about single nucleotide polymorphisms (SNPs) and/or copy number variation (CNV) or gene copy number (GCN) polymorphisms, i.e. variation of the amount of copies of a particular gene in the genotype of a subject. The GCN can, for example, be completely altered in cancer cells. Corresponding gene expression information may additionally be obtained in a specific embodiment.

Corresponding genetic or genomic variations, as well as their linkage to, for instance, diseases or disorders, are known to the person skilled in the art and/or can be derived from suitable data repositories, e.g. from data repositories at the National Center for Biotechnology Information (NCBI) at the NIH USA, accessible via www.ncbi.nlm.nih.gov, at the European Bioinformatics Institute (EBI) of the EMBL, accessible via www.ebi.ac.uk, in particular specific data collections such as the SNP database, OMIM, RefSeq, or repositories of signatures provided by the Human Genome Mutation Database etc.

In a particularly preferred embodiment, the signature data may be based on panels of genes or genomic regions which distinguish between at least two groups of subjects or situations, e.g. between a tumor state vs. a normal/healthy state; or between a malignant tumor state vs. a benign state; or between a state of chemosensitivity towards a pharmaceutical composition, e.g. a cancer drug vs. a state of chemoresistance towards a pharmaceutical composition, e.g. a cancer drug. In a specific embodiment of the present invention a method for processing a subject's genomic data may as defined herein may also cover situations in which modifications in genetic data may result in a further subsequent changes in it. Accordingly, the change in genetic data (δG^{n′}) may be predicted from (δG², δG³, . . . , δGⁿ⁻¹) by using signature data of known genetic diseases. If, for example, the predicted change δG^{n′} equals the actual change δGⁿ a subject may be considered as susceptible to that disease. In a further embodiment δGⁿ may be computed using the previous genetic changes, and may, hence, not be stored. Alternatively, the obtained data may be stored or temporarily be stored.

In another preferred embodiment of the present invention the step of reducing the complexity and/or amount of the genomic sequence information of the method for processing a subject's genomic data may be carried out by aligning a subject's genomic sequence with a reference sequence comprising signature data. Preferably, such a reference sequence (RefSeq) may comprise signature data pertaining to a disease or disorder, e.g. information on at least one variation specific to a disorder, disease, predisposition for disorders or diseases, risk factors for the development of diseases etc., selected from a missense mutation, a nonsense mutation, a single nucleotide polymorphism (SNP), a copy number variation (CNV), a splicing variation, a variation of a regulatory sequence, a small deletion, a small insertion, a small indel, a gross deletion, a gross insertion, a complex genetic rearrangement, an inter chromosomal rearrangement, an intra chromosomal rearrangement, the loss of heterozygosity, the insertion of repeats and/or the deletion of repeats and/or any combination of these signatures. Particularly preferred is the provision of a signature based reference sequence wherein all possible sequences for one, more than one or every genomic signature are present. In a further embodiment, these signatures may be combined with information on flanking sequences of a specific length, e.g. 100 bp, 200 bp, 500 bp, 1 kbp, 2 kbp, 5 kbp, 10 kbp, either upstream or downstream of the genomic variation or upstream and downstream of the genomic variation.

These signature reference sequences according to the present invention may be generated or provided in any suitable format or form. Preferred is a FASTA or FASTQ format. Further preferred is any recognizable format accepted by an aligner, preferably by multiple types of aligners.

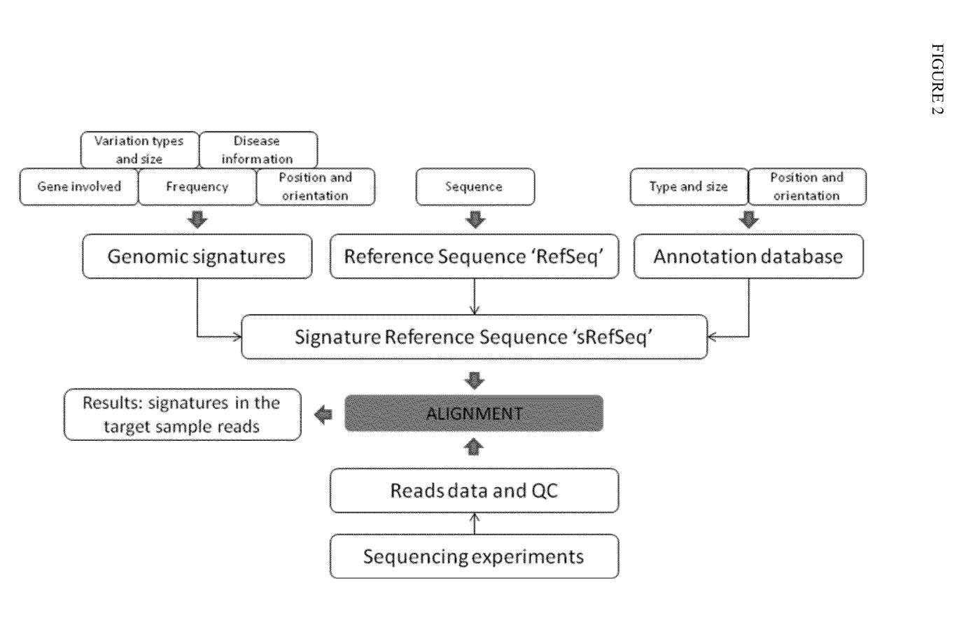

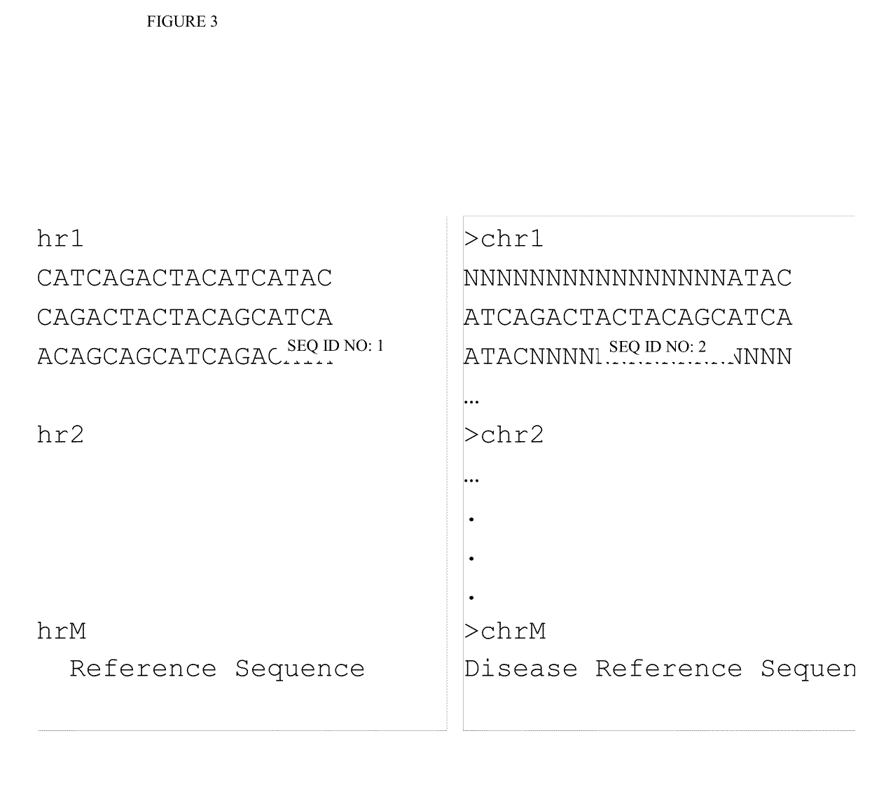

In a specific embodiment a signature reference sequence according to the present invention may be derived from a traditional reference sequence (e.g. genomic sequence information derivable from a data repository, such as NCBI), combined with genomic signatures including, for example data on diseases, information on the position and/or orientation of the genetic element, information on the gene involved, information on variation types and/or variation sizes; and/or information on the frequency of the variation. These data may further be combined with data derivable from annotation databases, e.g. relating to the position and/or orientation of genetic elements, and/or the type and size of these elements. An exemplary workflow is provided in FIG. 2.

In another embodiment a signature reference sequence according to the present invention may be adapted to the type of genomic variation to be detected and/or the type of genomic sequence information obtained or obtainable. These parameters may be combined or may be mutually exclusive.

For example, a signature reference sequence may be provided for a comparison with a genomic sequence present as single end and/or paired end data. Such a signature reference sequence may comprise information on substitutions, indels, SNPs, CNVs, regulatory modifications, missense or nonsense modification and the like. Based on this signature reference sequence known substitutions, indels, SNPs, CNVs, regulatory modifications, missense or nonsense modification present in the genomic sequence obtained from a subject may be detected. The signature reference sequence may be provided as FASTA file, e.g. as sRefSeqI.

In a further example, a signature reference sequence may be provided for a comparison with a genomic sequence present as paired end data. Such a signature reference sequence may comprise information on gross insertions, gross deletions, chromosomal aberrations, inter or intra chromosomal variations etc. Based on this signature reference sequence known gross insertions, gross deletions, chromosomal aberrations, inter or intra chromosomal variations etc. present in the genomic sequence obtained from a subject may be detected. The signature reference sequence may be provided as FASTA file, e.g. as sRefSeqII.

In a further example, a signature reference sequence may be provided for a comparison with a genomic sequence present single end data or as paired end data. Such a signature reference sequence may comprise information on genomic regions or interest, e.g. regions known to be varied or modified in the context of specific diseases or disorders, hotspots or modification etc. Based on this signature reference sequence regions known to be varied or modified in the context of specific diseases or disorders, hotspots or modification etc. present in the genomic sequence obtained from a subject may be detected. The signature reference sequence may be provided as FASTA file, e.g. as sRefSeqIII.

In yet another embodiment of the present invention a genomic sequence obtained from a subject as defined herein above may also be used as reference sequence. In such a reference sequence known variations, e.g. SNPs or substitutions may be searched.

In a typical embodiment a signature reference sequence as described above for the detection of substitutions, indels, SNPs, CNVs, regulatory modifications, missense or nonsense modification and the like (sRefSeqI) may be prepared by carrying out the following method steps:

(1) A list of signatures corresponding to substitutions, indels, SNPs, CNVs, regulatory modifications, missense or nonsense modification etc. may be prepared.

(2) The list of signatures may be sorted according to chromosomes, coordinate numbers, and orientation. Further included are identification codes, information on the normal sequence and information on the mutated sequence.

(3) The sequence may be extended based on sequence information available for both normal and mutated sequences. For example, 50, 100, 200, 300, 400, 500, 600, 700, 800, 900, 1000 bases on either side of the mutation may be included. Typically, the extension of the sequence from the mutation side may be taken as times (500 bases for read of 100 bases) the sequence read.

(4) A reverse complimentary sequence of both normal and mutated sequences may be generated.

(5) In case the mutations are close together the sequence may be extended form the mutation sites located at the end. A corresponding reverse complementary sequence of both normal and mutated sequence may be prepared.

In a further embodiment a signature reference sequence as described above for the detection of gross insertions, gross deletions, chromosomal aberrations, inter or intra chromosomal variations and the like (sRefSeqII) may be prepared by carrying out the following method steps:

(1) A list of signatures corresponding to gross insertions, gross deletions, chromosomal aberrations, inter or intra chromosomal variations etc. may be prepared.

(2) The mutated sequence may be provided according to information on the chromosomal variation. Furthermore, information on the chromosome, a description of the variation, and/or an identifying code may be provided.

(3) A reverse complementary sequence of the mutated sequence may be generated.

The alignment between the signature reference sequence and the genome sequence obtained from a subject may be carried out according to any suitable alignment method or technique. Examples of such methods can be derived from suitable publications, in particular from Li H. and Durbin R., 2009, “Fast and accurate short read alignment with Burrows-Wheeler transform”, Bioinformatics, 25, 1754-60 [PMID: 19451168]; or Li and Durbin R., 2010, “Fast and accurate long-read alignment with Burrows-Wheeler transform”; Bioinformatics, 26; 589-95 [PMID: 20080505], which are incorporated herein by reference in their entirety.

Preferably, the alignment is carried out by using reverse complementary sequences. These sequences may be already present in the signature reference sequences as described herein above, or provided according to methods as described herein. It is hence particularly preferred to use signature reference sequences comprising reverse complementary sequences. By bypassing any reverse complementing computation analysis time can significantly reduced, constituting a further advantage of the present invention.

In further embodiments of the present invention genomic sequence information reduced according to a method as described herein above, e.g. by aligning or comparing the sequence with a signature reference sequence as defined herein above, may subsequently be stored in a rapidly retrievable form, e.g. in the form of database entries, preferably in a differential DNA storage structure (DDSS) format or derivates thereof.

In another preferred embodiment of the present invention the method for processing a subject's genomic data additionally comprises steps of analysis of a subject's functional genetic information. Preferably, the method may comprise a step of obtaining a subject's functional genetic information, a step of reducing the complexity or amount of this information and a step of storing the functional genetic information in a rapidly retrievable form. The term “functional genetic information” as used herein comprises any type of molecular data referring to or implying a biological/biochemical function of the primary sequence or genomic sequence. The functional genetic information thus comprises, inter alia, (i) information on gene expression and/or (ii) methylation sequencing information, preferably methylation sequencing information for each individual nucleotide (C or A); and/or (iii) information on histone marks which may be indicative of active genes and/or silenced genes, preferably of H3K4 methylation and/or H3K27 methylation. Additional functional information may be associated with mutations, e.g. a single nucleotide polymorphisms which changes protein function and/or which has a regulatory impact as part of a noncoding RNA, or with a copy number variation as in amplified or deleted genes and non-coding RNAs, which are associated with a protein's function and/or has a regulatory impact as part of a non-coding RNA.

In a particularly preferred embodiment of the present invention the method for processing a subject's genomic data additionally comprises steps of analysis of a subject's gene expression. For example, the method may comprise a step of obtaining information on a subject's gene expression, a step of reducing the complexity or amount of this information and a step of storing the gene expression information in a rapidly retrievable form. The term “gene expression” as used herein relates to any type of information regarding the transcription, translation and/or post-translational modification of a gene or genetic element. Preferably, information on gene expression encompasses information on the presence or absence of one or more RNA species, on the presence or absence or one or more protein species, on a subject's transcriptome, on a subject's proteome or information on portions of a subject's transcriptome or proteome. Gene expression data may be obtained according to any suitable method known to the person skilled in the art, e.g. by performing microarray analysis, by carrying out PCR, in particular quantitative PCR analyses, by performing protein detection assays, 2D gel electrophoresis, 3D gel electrophoresis etc. Further suitable techniques would be known to the person skilled in the art or can be derived from qualified textbooks. Corresponding tests may be carried out with a sample derived from a subject, e.g. a sample as defined herein above. Preferably, the same sample, which is used for the acquisition of the genomic sequence, or a sample taken at the same time and/or at the same location or position, in the same organ, tissue or tissue type may be used for the analysis of a subject's gene expression. Alternatively, gene expression data may also be derived from information repositories, e.g. from databases providing information on gene expression pattern under specific conditions relevant for the subject's situation, such as relevant for a disease type, sex, age group etc. Furthermore, gene expression data obtained for a subject may be compared, normalized, standardized and/or corrected with reference to information obtainable from information repositories or suitable databases.

In a further, particularly preferred embodiment the complexity and/or amount of the functional genetic information, e.g. the information on gene expression, may be reduced. This reduction process is preferably carried out by cropping the functional genetic information, e.g. the gene expression information. The terms “cropping the functional genetic information” and “cropping the gene expression information” as used herein refer to a process of focusing on specific parameters, details or features of the available functional genetic information or gene expression information. For example, the functional genetic information may be reduced to information on specific genes, genetic elements, members of biochemical pathways, the methylation of specific regions, certain regulatory elements, specific bases in certain regions or the like. Similarly, the gene expression information may be reduced to information on the expression of specific genes, of certain genetic elements, or regions, of the expression of members of biochemical pathways, of the expression in reaction to the activation of pathways by transcription factors, growth factors or the like. Preferably, the functional genetic information and in particular the gene expression information may be reduced to signature data pertaining to a disease or disorder. For example, the functional genetic information, e.g. the gene expression information, may be cropped except for information known to be pertaining to a specific cancer disease. Thus, based on information known from the prior art as to, for example, methylation pattern, or expression pattern associated with such a disease only the methylation pattern or expression, e.g. presence or absence of RNA species, protein species etc., of relevant markers in this respect is determined.

In addition, further parameters of a subject's condition may be determined, e.g. histological parameters, parameters relating to cell sizes, known protein scores for diseases etc.

In a further preferred embodiment of the present invention the information on a subject's gene expression may be obtained initially, followed by a subsequent repetition of the obtaining step. Preferably, the acquisition of a subject's gene expression information may be repeated one time, two times, 3 times, 4 times, 5 times, 6 times or more often. The second or further acquisition may be carried out after a certain period of time, e.g. after 1 week, 2 weeks, 3 weeks, 4 weeks, 2, 3, 4, 5, 6, 7, 8, 9, 10, 11, 12 months, 1.5 years, 2 years, 3 years, 4 years, 5 years, 6 years etc. or after a longer period of time or at any suitable point in time in between these time points. The time periods between 1^{st} and a 2^{nd} and a 2^{nd} a subsequent acquisition of a subject's genomic sequence may be identical, essentially identical or may differ, e.g. increase or decrease. For instance, during a treatment monitoring, a subject's gene expression information may be obtained in equal or increasing or decreasing intervals. Preferably, the acquisition of a subject's gene expression information may be adjusted or harmonized with the acquisition of the subject's genomic sequence. Preferred is obtaining a subject's genomic sequence and a subject's gene expression information at essential the same time.

After a subject's gene expression information is obtained for a second or further time after the initial acquisition, or if more than one sets of gene expression information is provided, e.g. derived from different tissues or tissue types at a time, a comparison between the gene expression information obtained, e.g. in the initial acquisition and the gene expression information obtained in the second or further acquisition is performed. Preferably, such a comparison is carried out to reveal changes, modifications or differences between the initially obtained gene expression information and the subsequently obtained gene expression information, or between the gene expression information obtained in different locations, organs, tissues, cells etc. The term “comparison” as used herein relates to any suitable method or technique of matching expression data. Typically, clustering algorithms as known to the person skilled in the art may be employed. Examples of such algorithms include hierarchical clustering or k-means clustering. Further examples can be derived from suitable publications, in particular from A. K. Jain and R. C. Dubes, Algorithms for Clustering Data, Prentice Hall, 1988, which is incorporated herein by reference in its entirety.

In a preferred embodiment, a comparison is carried out between consecutive sets of functional genetic information, in particular gene expression information, e.g. between the functional genetic information, for instance the gene expression information, obtained initially and obtained in the 1^{st} repetition of said information acquisition etc.

In a particularly preferred embodiment, when a subject's functional genetic information, e.g. a subject's gene expression information, is obtained for a 2^{nd} or subsequent time, the incremental data in comparison to the information of the previously stored functional genetic information, e.g. the previously stored gene expression information is stored. Thus, the information which has changed or which differs between two sets of functional genetic information, e.g. two sets of gene expression information may be stored.

In a specific embodiment, e.g. when a subject's gene expression information is obtained more than two times, when the data is presented for the second time, the changes in the gene expression data may be identified (i.e., the difference between E² and E¹) and only the changed segments will be stored (δE²). When the gene expression data is presented for the n^{th} time (Eⁿ), the previous genetic data (Eⁿ⁻¹) may be reconstructed as

$${E}^{n - 1} = {E}^{1} + {\sum }_{i = 2}^{n - 1} δ {E}^{i}$$

The changes if any between Eⁿ and Eⁿ⁻¹ may be detected and stored as δEⁿ. The advantage of such a process is that memory and storage space required for storing the functional genetic information, in particular gene expression information can be reduced drastically.

In a further embodiment of the present invention the information on a subject's functional genetic information, e.g. a subject's gene expression as described herein may (i) be stored together with the information on the genomic sequence and/or (ii) linked with the information on the genomic sequence. Particularly preferred is a step of combining both information sets, i.e. genomic sequence information and functional genetic information, e.g. gene expression information focused on a specific disease or disorder, allowing for an interpretation of a subject's health situation by a mutually influenced interpretation of the data.

Furthermore, due to the acquisition of incremental data over time, the course of functional genetic variation, in particular the course of gene expression in dependence on the situation of the genomic sequence may be observed, e.g. during the treatment of a disease, during the course of a disease etc. This combination of information advantageously offers a possibility of allowing a more detailed interpretation of the subject's response to a treatment, the development of a disease, the subject's prospect etc.

In another aspect the present invention relates to the use of genomic sequence information as obtained, processed, and/or stored according to methods described herein for diagnosing, detecting, monitoring, or prognosticating a disease. In an specific embodiment the genomic sequence information as obtained, processed, and/or stored according to methods described herein in combination with functional genetic information, in particular with gene expression information as obtained, processed, and/or stored according to methods described herein may be used for diagnosing, detecting, monitoring, or prognosticating a disease.

The term “diagnosing a disease” as used herein means that a subject may be considered to be suffering from a disease when the genomic sequence information obtained initially differs from a predefined state typical for the subject's genetic condition. The term “predefined state typical for the subject's genetic condition” as used herein means that on the basis of prior art knowledge or examinations one or more specific genetic and/or functional genetic conditions, e.g. gene expression conditions are assumed to be healthy, whereas deviations from said conditions are assumed to be associated with a disease. The term “diagnosing” also refers to the conclusion reached through that comparison process.

The term “detecting a disease” as used herein means that the presence of a disease or disorder in a subject may be identified in said organism. The determination or identification of a disease or disorder may be accomplished by the elucidation of genomic sequence modifications. More preferably said determination or identification of a disease or disorder may be accomplished by the elucidation of genomic sequence modifications and of functional genetic changes, e.g. gene expression changes as described herein.

The term “monitoring a disease” as used herein relates to the accompaniment of a diagnosed or detected disease or disorder, e.g. during a treatment procedure or during a certain period of time, typically during 1 day, 2 day, 5 days, 1 week, 2 weeks, 4 weeks, 2 months, 3 months, 4 months, 5 months, 6 months, 1 year, 2 years, 3 years, 5 years, 10 years, or any other period of time. The term “accompaniment” means that states of and, in particular, changes of these states of a disease may be detected based on the incremental information obtained according to the methods of the present invention, or on the basis of corresponding database values in any type of periodical time segment, e.g. every week, every 2 weeks, every month, every 2, 3, 4, 5, 6, 7, 8, 9, 10, 11 or 12 month, every 1.5 year, every 2, 3, 4, 5, 6, 7, 8, 9 or 10 years, during any period of time, e.g. during 2 weeks, 3 weeks, 1, 2, 3, 4, 5, 6, 7, 8, 9, 10, 11, 12 months, 1.5, 2, 3, 4, 5, 6, 7, 8, 9, 10, 15 or 20 years, respectively.

The term “prognosticating a disease” as used herein refers to the prediction of the course or outcome of a diagnosed or detected disease, e.g. during a certain period of time, during a treatment or after a treatment. The term also refers to a determination of chance of survival or recovery from the disease, as well as to a prediction of the expected survival time of a subject. A prognosis may, specifically, involve establishing the likelihood for survival of a subject during a period of time into the future, such as 6 months, 1 year, 2 years, 3 years, 5 years, 10 years or any other period of time.

Preferably, information on the disease, e.g. diagnostic or prognostic information may be stored in a rapidly retrievable form.

In another embodiment the present invention envisages the use of a method as defined herein for the preparation of the molecular history of a subject, or the documentation of said molecular history. The term “molecular history” as used herein refers to a capture of functional aspects of the complete genome, or sub-portions thereof as defined herein above, or of the regulome, or of the regulatory state of the genome, genomic regions, genes, promoters, introns, exons, pathways, pathway members, methylation states etc. over a defined period of time. The history may, in one embodiment, also include various molecular profiling modalities. In a preferred embodiment the molecular history may be generated over a period of days, 1 to 7 days, weeks, e.g. 1, 2, 3, 4, 5, 6, 7, 8, 9, 10 weeks, months, e.g. 1, 2, 3, 4, 5, 6, 7, 8, 9, 10, 11, 12 months, or years, e.g. 1, 2, 3, 4, 5, 6, 7, 8, 9, 10, 15, 20, 25 or more years. Functional aspects of the complete genome, or sub-portions thereof as defined herein above, or of the regulome, or of the regulatory state of the genome, genomic regions, genes, promoters, introns, exons, pathways, pathway members, methylation states etc. as well as their changes may be captured at any suitable interval, e.g. periodically every 1 to 7 days, 1, 2, 3, 4, 5, 6, 7, 8, 9, 10 weeks, 1, 2, 3, 4, 5, 6, 7, 8, 9, 10, 11, 12 months, 1, 2, 3, 4, 5, 6, 7, 8, 9, 10 years etc. The capture may alternatively also be carried out non-periodically, e.g. when the patient visits a physician or genomics' professional. The molecular history may advantageously be provided in a rapidly retrievable, easily accessible form. Preferred are the formats which focus on specific molecular signatures associated with one disease or a confined group of diseases. This information may, in a further embodiment, also be linked with other clinical indicators, which are not directly associated with the disease, but provide information on the subject's health condition.

The disease or disorder to be determined, detected, diagnosed, monitored or prognosticated according to the present invention may be any detectable disease known to the person skilled in the art. In a preferred embodiment said disease may be a genetic disease or disorder, in particular a disorder, which can be detected on the basis of genomic sequence information. Such disorders include, but are not limited to, the disorders mentioned, for example, in suitable scientific literature, clinical or medical publications, qualified textbooks, public information repositories, internet resources or databases, in particular one or more of those mentioned in http://en.wikipedia.org/wiki/List_of_genetic_{—} disorders.

In a particularly preferred embodiment of the present invention said disease is a cancerous disease, e.g. any cancerous disease or tumor known to the person skilled in the art. More preferably, the disease is breast cancer, ovarian cancer, or prostate cancer.

In another aspect the present invention relates to a clinical decision support and storage system comprising an input for providing a subject's genomic sequence information and its functional readout, for example gene or non-coding RNA expression, or protein levels; a computer program product for enabling a processor to carry out the step of reducing the complexity and/or amount of the genomic sequence information as defined herein, an output for outputting a subject's genomic variation, incremental genomic change or gene expression variation pattern, and a medium for storing the outputted information. In a specific embodiment the clinical decision support and storage system may comprise an input for providing a subject's genomic sequence information in combination with a subject's gene expression information; a computer program product for enabling a processor to carry out the step of reducing the complexity and/or amount of the genomic sequence information and the step of reducing the complexity and/or amount of the gene expression information as defined herein, an output for outputting a subject's genomic variation, incremental genomic change or gene expression variation pattern, and a medium for storing the outputted information.

In a specific embodiment said clinical decision support and storage system may be a molecular oncology decision making workstation, preferably with longitudinal data capturing the molecular history of the person or patient. The decision making workstation may preferably be used for deciding on the initiation and/or continuation of a cancer therapy for a subject. More preferably, the decision making workstation may be used for deciding on the probability and likelihood of responsiveness to a therapy. Further envisaged are similar decision making workstation for different disease types, e.g. for any of the diseases as mentioned herein above.

In a further embodiment the present invention also envisages a software or computer program to be used on a decision making workstation as described herein. The software may, in one embodiment, be based on the analysis of genomic sequence information as described herein. For example, the software may implement the method steps for reducing the complexity and/or amount of genomic sequence information as described herein. In a further embodiment the software may additionally implement the method steps for reducing the complexity and/or amount of gene expression information as described herein. In yet another specific embodiment, the software may implement comparison steps based on a signature reference sequence as described herein above. In another embodiment, the software may implement a documentation of the molecular history of a subject.

Outputted resulting data may accordingly be stored in any suitable manner or format, preferably in a storage structure, which is 1) hierarchical, and/or 2) encodes time information and/or additionally 3) contains links to patient data, images, reports etc. Even more preferred is a storage structure such as Differential DNA Storage Structure (DDSS).

In yet another particularly preferred embodiment of the present invention, the clinical decision support and storage system may be an electronic picture/data archiving and communication system. Examples of such electronic picture/data archiving and communication systems are PACS systems. Particularly preferred are iSite PACS systems, as provided by Philips. These systems may be adjusted or modified in order to comply with the requirements of the methods of the present invention and/or in order to be able to carry out a computer program or algorithm as described herein, and/or in order to store genomic sequence information and/or functional genetic information as defined herein.

The following examples and figures are provided for illustrative purposes. It is thus understood that the example and figures are not to be construed as limiting. The skilled person in the art will clearly be able to envisage further modifications of the principles laid out herein.

### EXAMPLES

### Example 1

### Comparison of Alignment Parameters

A current limit set by alignment algorithms is typically at a maximum of 5 mismatches (e.g. substitution, gap) and a maximum of 3 insertions and deletions. Generally, 2 bp mismatches are used as default input parameters for optimizing the memory/processor usage and running time. Without which the number of targets would blow up with parameters beyond that. However, this is much less than what is required if we a search for larger insertions and deletions is to be carried out. How many reads match and variations called from the RefSeq is directly proportional to input parameters as shown in Table 1. Table 1 shows 11M RNA-Seq reads to mouse chr19 using 2 bp and 3 bp mismatch mapping, respectively. It can accordingly be seen that 3 bp mapping gives 18.5% more uniquely mapped reads and 42% of them fall into transcribed regions annotated by traditional RefSeq genes, which occupies only 2˜3% of the genome.

TABLE 1
read alignment to RefSeq with different mismatch allowed.

| Mapping | Uniquely mapped | Reads mapped to |
|---|---|---|
| parameters | reads | transcribed regions |
| 2 bp mismatch | 308,095 | 195,986 |
| 3 bp mismatch | 365,172 | 220,050 |

With smaller disease/application specific focused reference sequences as described in the present invention (e.g. sRefSeqI, sRefSeqII, sRefSeqIII) the number of mismatch and indels can be increased, thereby making it possible to detect larger genomic variations, which have a high clinical significance.

### Example 2

### Monitoring of a Patient's Response to Therapy Over Time

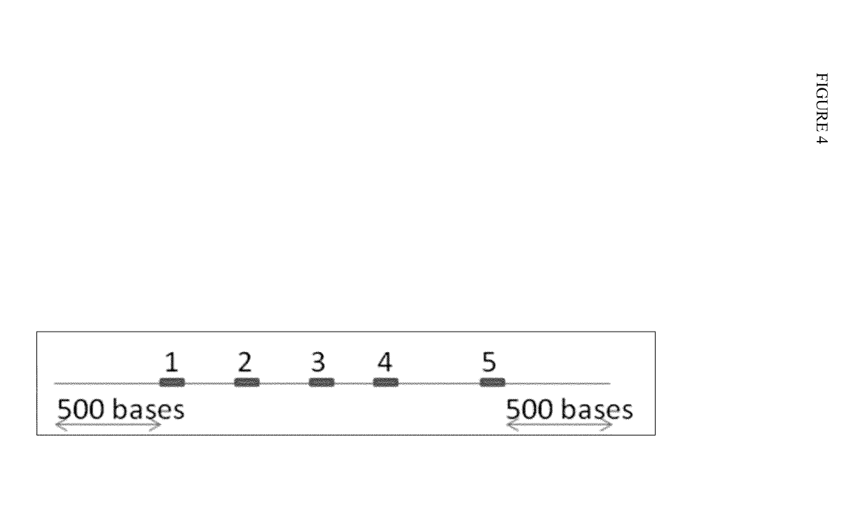

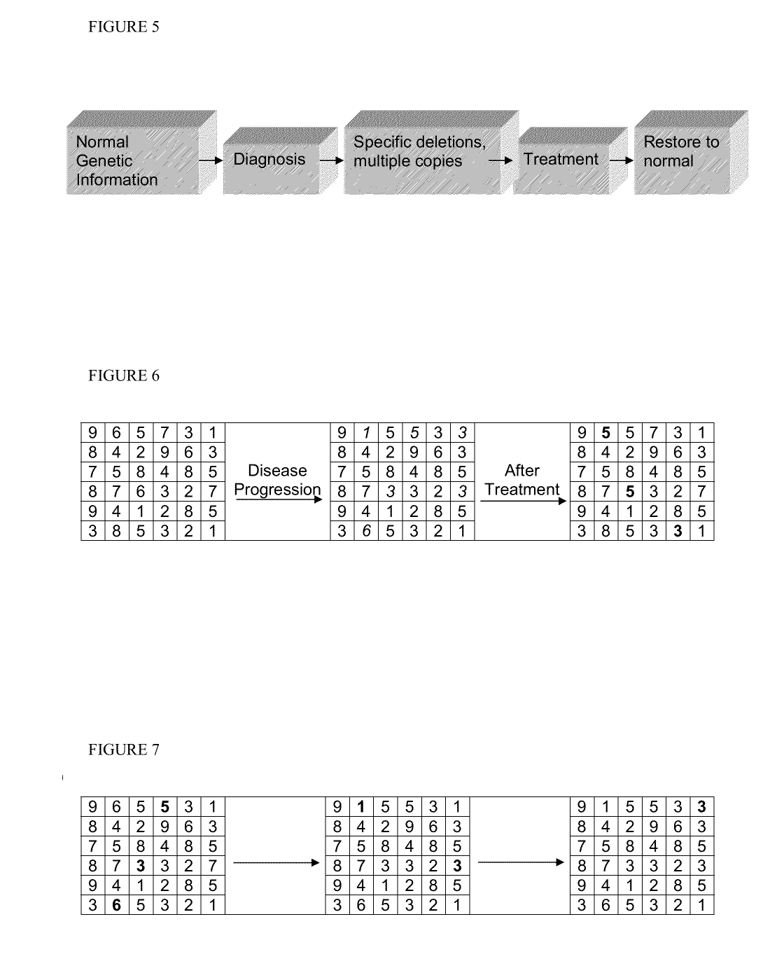

The incremental information as obtained according to the methods of the present invention can be used to monitor how a patient is responding to therapy over time (see FIG. 5). The δGs calculated after the patient is put on treatment can be checked to see how quickly he/she is responding to therapy. If the changes are minimal, then the patient has either fully recovered if Gⁿ equals G¹ or is not responding well to therapy, in which case an alternate therapy should be employed.

### Example 3

### Prediction of Disease Trends

The incremental information can also be used to track as well as predict the disease trends which in turn can be used for diagnosis and staging of disease (e.g. cancer). For example, if the δGs of patients (during the diagnosis phase) who have suffered with a particular disease are available, they can be used to detect the key genetic changes during the progression of the disease. This information can be used to detect the early onset of the disease in other patients. Also, they can be used to identify the influence of the genetic makeup of a person on disease progression. For example, in a cancer patient who has a normal profile (see FIG. 6), changes may be detected that diagnose the patient as having colorectal cancer. Going through chemotherapy and radiation therapy may result in a normal profile which is very close to the one before the disease was diagnosed. The values in the matrices could represent levels of RNA signal (gene expression data or values of gene copy number polymorphisms).

During the disease progression multiples of further molecular data surpassing the data provided in FIG. 6 may become relevant. There could, for example, be one sequencing experiment three days after each chemotherapy treatment session in order to see the overall response to treatment. At each point in time, usually a diagnostic image may also taken (e.g. MRI) and the differential data may be stored over time.

In FIG. 6 in the disease progression stage 6 values have changed dramatically, and then after treatment 3 of these values go back to normal and 3 values come close to the original values. Accordingly, in the molecular history storage δG² will have 6 values, and δG³ will have 3 values. The δG² will represent a profile that is matched against a known profile for this stage of the disease. In real life example, the number of values may be, for example, 3164.7 million chemical nucleotide bases (A, C, T, and G).

### Example 4

### Rate of Progression of a Disease

A patient may undergo several genetic tests during the progression of a disease. The changes between two successive tests conducted with lesser time gap may be minimal but still may offer critical information regarding the rate of progression of the disease. FIG. 7 shows the variation in gene copy numbers (GCN) during the progression of the disease for the example given in FIG. 6. The number of δGs are three, two and one respectively for the various stages shown. For example, techniques discussed in Tjaden et al, 2006, Applied Mycology and Biotechnology: Bioinformatics, 6 can be applied to analyze the incremental data. For instance, when the incremental data of various patients suffering from the same disease are available at equal instances of time from the onset of the disease, they can be clustered using k-means method into various classes based on the rate of the progression of the disease. When the incremental data of a new patient is presented, it can be compared with the k-means (or centroids) and the rate of progression can be estimated. This may help in choosing an appropriate treatment for the patient. With each cluster, a category of patients can be associated, such as: “responds to chemotherapy positively” i.e. this cluster is closer to the original cluster (healthy state) vs. cluster that signifies “does not respond to chemo therapy” i.e. the values in δGs are getting higher and further than the matrices in the “healthy” cluster.

1. A method for processing a subject's genomic data comprising
(a) obtaining a subject's genomic sequence information;
(b) reducing the complexity and amount of said genomic sequence information comprising cropping said genomic sequence information except for the signature data pertaining to a disease or disorder; and
(c) storing said genomic sequence information of step (b) in a rapidly retrievable form.

2. The method of claim 1, wherein said genomic sequence is obtained from a subject's sample, preferably from a mixture of tissues, organs, cells and/or fragments thereof, or from a tissue or organ specific sample, such as a tissue biopsy from vaginal tissue, tongue, pancreas, liver, spleen, ovary, muscle, joint tissue, neural tissue, gastrointestinal tissue, tumor tissue, body fluids, blood, serum, saliva, or urine.

3. The method of claim 1, wherein step (a) comprises a repeated acquisition of a subject's genomic sequence and wherein a comparison between the genomic sequence information obtained in the initial acquisition and the genomic sequence information obtained in a second or further acquisition is performed.

4. The method of claim 3, wherein in an additional step the incremental data comprising information which differs between the initially obtained genomic sequence information and the genomic sequence information obtained in a second or further acquisition is stored in a rapidly retrievable form.

5. (canceled)

6. The method of claim 1, wherein step (b) is carried out by aligning a subject's genomic sequence with a reference sequence comprising signature data pertaining to a disease or disorder and wherein said alignment is carried out by using reversed complementary sequences.

7. The method of claim 1, wherein said signature data is at least one variation specific to a disease or disorder selected from the group comprising missense mutation, nonsense mutation, single nucleotide polymorphism (SNP), copy number variation (CNV), splicing variation, variation of a regulatory sequence, small deletion, small insertion, small indel, gross deletion, gross insertion, complex genetic rearrangement, inter chromosomal rearrangement, intra chromosomal rearrangement, loss of heterozygosity, insertion of repeats and deletion of repeats.

8. The method of claim 1, wherein said method additionally comprises the steps of (d) obtaining the subject's functional genetic information, (e) reducing the complexity and/or amount of this information, and (f) storing the functional genetic information in a rapidly retrievable form, wherein the step of reducing the complexity and/or amount of said functional genetic information is carried out by cropping said functional genetic information except for signature data pertaining to a disease or disorder.

9. The method of claim 8, wherein said functional genetic information comprises (i) information on gene expression, preferably information on the presence of one or more RNA species, of one or more protein species, of the subject's transcriptome or a portion thereof, of the subject's proteome or a portion thereof, or a mixture thereof; and/or (ii) methylation sequencing information, preferably methylation sequencing information for each individual nucleotide (C or A); and/or (iii) information on histone marks which are indicative of active genes and/or silenced genes, preferably of H3K4 methylation and/or H3K27 methylation.

10. (canceled)

11. The method of claim 1, wherein changes in genomic and/or functional genetic information are encoded in matrices, and wherein information pertaining to the status of a gene, genomic region, regulatory region, promoter, exon or pathway, preferably in the context of a disease or disorder, is decoded and represented based on Markov chain processes.

12. Use of genomic sequence information, optionally in combination with gene expression information, as obtained and/or stored according to claim 1, for (i) the preparation of a subject's molecular history, in the form of various molecular profiling modalities by capturing information on the complete genome, the regulome, or the regulatory state of the genome, genomic regions, genes, promoters, introns, exons, pathways, pathway members or methylation states over a defined period of time; and/or for (ii) diagnosing, detecting, monitoring or prognosticating a disease.

13. The method of claim 1, wherein said disease is a cancerous disease, preferably breast cancer, ovarian cancer or prostate cancer.

14. A clinical decision support and storage system comprising:
an input for providing a subject's genomic sequence information, optionally in combination with a subject's s functional genetic information;
a computer program product for enabling a processor to carry out step (b) and optionally step (e) of the method of claim 1,
an output for outputting a subject's genomic variation, incremental genomic change or gene expression variation pattern, over a defined period of time, and
a medium for storing the outputted information.

15. The system of claim 14, wherein said system is an electronic picture/data archiving and communication system.
